(19) United States
(12) Patent Application Publication
(10) Pub. No.: US 2013/0130963 A1
(43) Pub. Date: May 23, 2013

(54) PACKAGING FOR A LIQUID DETERGENT COMPOSITION WITH ABRASIVE PARTICLES

(71) Applicant: THE PROCTER & GAMBLE COMPANY, Cincinnati, OH (US)

(72) Inventors: Eva Maria Perez-Prat Vinuesa, Singapore (SG); Denis Alfred Gonzales, Brussels (BE); Robby Renilde Francois Keuleers, Lippelo (Sint-Amands) (BE)

(73) Assignee: THE PROCTER & GAMBLE COMPANY, Cincinnati, OH (US)

(21) Appl. No.: 13/674,976

(22) Filed: Nov. 13, 2012

(30) Foreign Application Priority Data
Nov. 18, 2011 (EP) 11189666.8

(51) Int. Cl. C11D 17/08

(52) U.S. Cl. CPC C11D 17/08
USPC 510/236

(57) ABSTRACT

A packaged product comprising a packaging in combination with a composition, said composition comprising at least one surfactant and abrasive particles to provide both cleaning of a surface and mild skin exfoliation benefits, wherein said composition consists of a liquid composition and said packaging comprises a textured surface to provide tactile cues to the delivery of the cleaning and exfoliating benefits of said composition.

### FIELD OF INVENTION

The present invention relates to a packaged product comprising a packaging and a liquid composition therein. The liquid composition comprising one or more surfactants and abrasive particles, typically such composition is in the form of a liquid dishwashing composition.

### BACKGROUND OF THE INVENTION

Packaged products are well known in the industry of detergents. A vast variety of bottles comprising recessed regions exists in the art, most related to either providing ergonomic benefits to aid the user in gripping the bottles for ease of dispensing, or merely for aesthetic purposes. An example being EP0460765A1.

However, there still remains a need for a packaging that accurately transmits the key benefits provided by the product contained within the packaging to the user via tactile impression upon contacting said packaging with the skin.

The present invention provides a packaged product comprising a packaging in combination with a composition, said composition comprising at least one surfactant and abrasive particles to provide both cleaning of a surface and mild skin exfoliation, wherein said composition consists of a liquid composition and said packaging comprises a textured surface that is adapted to impart, to the user, analogous tactile cues to those provided by the particles comprised in said composition, during use, and delivers a perception of the cleaning and exfoliating properties of said particles directly on said packaging.

An advantage of such a combination is that the user is encouraged in a wholly intuitive way to clean a surface with the composition and to contact the composition with his/her hands over time in order to obtain the dual benefit of cleaning and mild exfoliation provided by said composition.

Other advantages of the present invention will become apparent with reference to the drawings and detailed description herein.

### SUMMARY OF THE INVENTION

The present invention relates to a packaged product comprising a packaging in combination with a composition, said composition comprising at least one surfactant and abrasive particles to provide both cleaning of a surface and mild skin exfoliation benefits, wherein said composition consists of a liquid composition and said packaging comprises a textured surface to provide tactile cues to the delivery of the cleaning and exfoliating benefits of said composition.

### BRIEF DESCRIPTION OF THE FIGURES

FIG. 1 is a front view of a container comprising a composition therein, according to an embodiment of the present invention.

FIG. 2 is an enlargement of section A.

FIG. 3 is a cross-section taken along line Y-Y of the enlargement of FIG. 2.

### DETAILED DESCRIPTION OF THE INVENTION

As used herein “z-axis” means the axis parallel to the height of the protrusion(s) H.

As used herein “x-y plane” means the plane perpendicular to the z-axis.

As used herein “grease” means materials comprising at least in part (i.e., at least 0.5 wt % by weight of the grease) saturated and unsaturated fats and oils, preferably oils and fats derived from animal sources, such as beef and/or chicken; and/or vegetable sources.

As used herein “shelf stable” means a neat hand dishwashing liquid detergent composition that under ambient conditions does not phase separate for at least two weeks, preferably for at least six months, and more preferably never.

As used herein “dishware” refers to a hard surface such as dishes, glasses, pots, pans, baking dishes and flatware made from ceramic, china, metal, glass, plastic (polyethylene, polypropylene, polystyrene, etc.), wood, enamel, Inox®, Teflon®, or any other material commonly used in the making of articles used for eating and/or cooking.

As used herein “liquid dishwashing detergent composition” refers to those compositions that are employed in manual (i.e. hand) dishwashing. Such compositions are generally high sudsing or foaming in nature and are shelf stable.

As used herein “hand skin care benefit” means any benefit relating to hand skin appearance (such as smoothness, elasticity, absence of redness and absence of lines and wrinkles), skin feel (such as softness and suppleness), and skin moisture level.

As used herein “mild skin exfoliation” means removal of dead skin cells from the outermost layer of the skin whilst minimizing the risk of over-exfoliating the skin, which may otherwise result in damaged and red hands.

As used herein “suds profile” means amount of sudsing (high or low) and the persistence of sudsing (sustained or prevention) throughout the washing process resulting from the use of the liquid detergent composition.

As used herein “polyurethane foam” means a polyurethane structure having a lightweight cellular form resulting from the introduction of gas bubbles (or by other suitable means) during manufacture.

As used herein “polyurethane foam particles” means particles formed by shearing, grinding, milling, and/or graining polyurethane foam.

As used herein “polymeric material foam” means a polymeric structure having a lightweight cellular form resulting from the introduction of gas bubbles (or by other suitable means) during manufacture.

As used herein “natural abrasive particles” means particles derived from materials readily found in nature. Such particles are selected from the group consisting of nut shell particles; particles derived from other plant sources; and mixtures thereof.

As used herein “tactile cues” means the tactile impression delivered to a user when touching matter having predetermined tactile characteristics.

The term “perception” as used herein means a response to a sensory stimuli, such as the sense of touch, that triggers awareness of benefits directly linked with the properties of the matter touched, by physical sensation.

The term “matter” as used herein means any physical object or portion of an object, such as a textured surface of a packaging, container, or bottle.

As used herein “blunt” means devoid of sharp edges.

### Packaging

The packaged product according to the present invention comprises a packaging, preferably a container, more preferably a bottle, in combination with a composition, preferably a hand dishwashing composition, comprising abrasive particles, to provide both cleaning of a surface and mild skin exfoliation, preferably whilst minimizing scratching and/or damaging of a surface, wherein the packaging comprises a textured surface to provide tactile cues to the delivery of the cleaning and exfoliating benefits of said composition. The composition consisting of a liquid composition.

The textured surface may be adapted to impart, to the user, analogous tactile cues to those provided by the particles comprised in said composition, during use, and to provide a resemblance of the cleaning and exfoliating properties of said particles directly on said packaging. The textured surface is arranged such that it provides a tactile impression to the user that communicates the mild skin exfoliation and superior cleaning of the particles comprised in the composition therein.

The packaging may be clear and/or opaque, preferably clear. Such packaging may be made of any suitable material such as glass or plastic. The packaging could be either used upright and/or upside down. The packaging may be in the form of a spray container or bottle, preferably selected from the group consisting of aerosol, such as non-bag-in-can containers and/or bottles further containing a propellant therein, and non-aerosol, such as bag-in-can, trigger spray containers and/or bottles with or without further comprising a propellant therein. In a preferred embodiment the packaging is a non-aerosol container or bottle.

The packaging suitable for the present invention can be made of any suitable plastic resin material. Preferred plastic resin materials for use in the present invention can be polyolefins (such as PP and PE), polystyrene (PS), polyvinyl chloride (PVC), polylactic acid (PLA) or polyethylene terephthalate (PET). In one embodiment, the plastic resin material is polyethylene terephthalate (PET). Alternatively, the packaging herein may be made of sustainable materials selected from the group consisting of renewable materials, recycled materials, regrind materials, and mixtures thereof.

Examples of “renewable materials” include bio-polyethylene, bio-polyethylene terephthalate, and bio-polypropylene. As used herein and unless otherwise stated, “polyethylene” encompasses high density polyethylene (HDPE), low density polyethylene (LDPE), linear low density polyethylene (LLDPE), and ultra low density polyethylene (ULDPE). As used herein and unless otherwise stated, “polypropylene” encompasses homopolymer polypropylene, random copolymer polypropylene, and block copolymer polypropylene.

Examples of “recycled” materials include post-consumer recycled (PCR) materials, post-industrial recycled (PIR) materials, and mixtures thereof.

Examples of “regrind” material include thermoplastic waste material, such as sprues, runners, excess parison material, and reject parts from injection and blow molding and extrusion operations, which has been reclaimed by shredding or granulating.

The packaging for use herein may be made by any suitable process, such as blow molding, thermoforming, injection molding, and combinations thereof. Preferably, the packaging is made by a blow molding process.

In a preferred embodiment, the packaging herein is formed by extrusion blow molding, injection blow molding, stretch blow molding and combinations thereof, preferably by injection stretch blow molding.

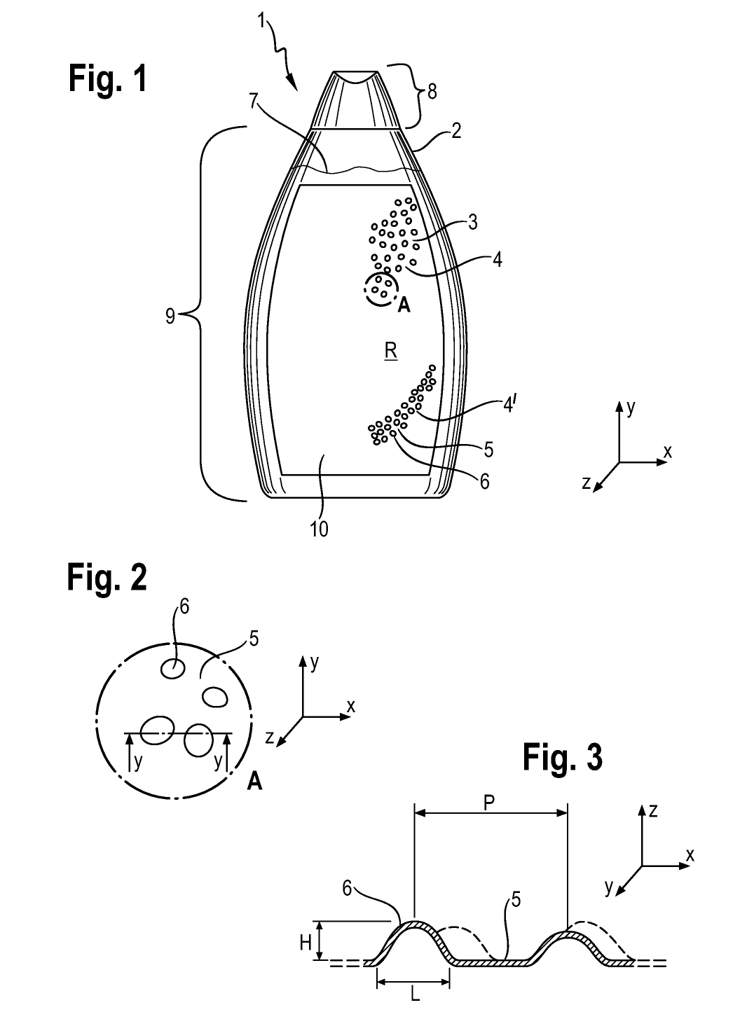

Referring to FIGS. 1 and 2, the packaged product 1 comprises a composition 7 and a packaging 2, said composition 7 comprising abrasive particles as described hereinafter. The packaging 2 comprises a textured surface 3, preferably consisting of a plurality of recesses 5 and protrusions 6 on at least a portion 4, 4′ of said packaging 2, preferably said at least a portion 4, 4′ comprises at least a first portion 4 and at least a second portion 4′ wherein said at least first portion 4 is separated from said at least second portion 4′ by a region R which is free of said plurality of recesses 5 and/or protrusions 6.

In a preferred embodiment said packaging 2 comprises a closure 8 and a body 9, and wherein said textured surface 3 is located on at least a portion 4, 4′ of said body 9.

Referring to FIG. 3, the plurality of recesses 5 and/or protrusions 6 may be substantially blunt. Such plurality of recesses 5 and/or protrusions 6 may comprise a smooth and curved profile, preferably said plurality of recesses 5 and/or protrusions 6 are respectively concave and/or convex in shape. In a preferred embodiment the protrusions have an aspect ratio (H:L) of greater than 1, preferably greater than 1.2, more preferably between 1.5 and 5, even more preferably from 1.8 to 4, most preferably from 2 to 3. Without wishing to be bound by theory it is believed that having the correct aspect ratio ensures greater similarity to the roughness of the particles, i.e. sufficiently elongate in shape to provide the tactile cue associated with effective cleaning and mild skin exfoliation but not too much so as to avoid communicating signals such as potential over-exfoliation or scratching or damaging of a surface.

In an embodiment, the protrusions 6 and/or recesses 5 are circular or non-circular in shape, in the x-y plane, preferably non-circular. Suitable non-circular shapes are selected from the group consisting of elliptical; polygonal, such as star shaped, triangular and trapezoidal; and combinations thereof.

In a preferred embodiment, each said recess is delimited by at least one protrusion, more preferably each said protrusion is delimited by at least one recess.

In a highly preferred embodiment the peak-to-peak distance “P” between two neighboring protrusions is greater than, preferably at least 1.5 times, more preferably at least 2 times, even more preferably from 2 to 5 times, most preferably from 3 to 4 times, the length “L” of one said protrusion, as measured using the test method described herein.

The peak-to-peak distance “P” may be from 1 mm to 20 mm, preferably from 3 mm to 15 mm, more preferably from 4 mm to 12 mm, even more preferably from 4 mm to 10 mm, most preferably from 4 mm to 7 mm, measured using the methods described herein.

In a highly preferred embodiment the plurality of recesses 5 and protrusions 6 generate a substantially random pattern, meaning that the peak-to-peak distance “P” between multiple consecutive protrusion is unequal. Without wishing to be bound by theory it is believed that such random pattern provides a tactile cue which triggers the user's association with the cleaning and exfoliating efficacy of the particles in the composition since this generates a variability in the sensory perception as the user rubs such surface with the skin, thus amplifying the noticeability of such textured surface to provide a signal of efficacy.

Similarly, in a preferred embodiment, the height “H” of the protrusions 6 is substantially random, meaning that multiple adjacent protrusions 6 have unequal height “H”. The advantage of such embodiment is similar to that described above.

The height “H” may be of from 0.5 mm to 5 mm, preferably from 1 mm to 4 mm, more preferably from 2 mm to 4 mm, even more preferably from 3 mm to 4 mm, measured from the lowest point of the adjacent recess 5 to the apex of the protrusion 6 being measured. Such height “H” may be measured using the test method described herein.

The textured surface 3 may be on the body 9 of said packaging 2. Alternatively, or in addition, said packaging 2 may further comprise an overlaying material 10 preferably selected from the group consisting of adhesive labels, sleeves, and combinations thereof, wherein said textured surface 3 is on said overlaying material. Advantages of such embodiment include, simplicity of manufacture and reduced cost. The combination of a textured surface 3 on the body 9 and on the overlaying material 10, may provide greater three-dimensionality and amplify the perceptions received by the user via the tactile cues provided by the textured surface 3.

The textured surface 3 may be provided with means to attract the user to touch said textured surface 3, such as colour or coatings with contrasting materials. Alternatively the refractive properties of the textured surface 3 itself may be arranged such that the shadow areas and light areas attract the user to touch said textured surface 3. In a preferred embodiment labeling, preferably selected from the group consisting of decorative artwork, shapes, text, images and combinations thereof, with optional visual connotation of particles, is applied onto said textured surface 3 and used to attract the user to touch said textured surface 3.

In a preferred embodiment the protrusions 6 are elevated from the outer packaging surface, said outer packaging surface being the surface opposite the surface of the packaging 2 that is in contact with said composition 7.

### The Composition

The composition suitable for use herein is typically formulated as a liquid dishwashing detergent composition comprising abrasive particles. Such compositions may be single phase and/or multiphase and be in liquid and/or gel form and/or may be provided in unit dose form. Furthermore, the compositions herein may comprise isotropic or non-lamellar phases, lamellar phases or mixtures thereof. It is generally accepted that lamellar phases are less preferred, however, in some embodiments, lamellar phases may be present. The liquid dishwashing compositions herein may further contain from 30% to 90% by weight of an aqueous liquid carrier that preferably comprises water, more preferably consists of water.

The liquid dishwashing composition may have any suitable pH. Preferably the pH of the composition is adjusted to between 4 and 14. Typically, the composition has pH of between 6 and 13, preferably between 7 and 10, more preferably between 7 and 9, and most preferably between 8 and 9. The pH of the composition can be adjusted using pH modifying ingredients known in the art.

### Abrasive Particles

The compositions for use herein comprise abrasive particles, preferably selected from the group consisting of natural abrasive particles, polymeric abrasive particles, and mixtures thereof. The polymeric abrasive particles, preferably, being derived from a polymeric material foam such as polyurethane foam.

The abrasive particles of the present invention provide a dual benefit to the user: Firstly, excellent removal of tough food soils from dishware without substantially damaging delicate surfaces such as stainless steel, Inox®, Teflon®, painted and or decorated ceramic, crystal, and plastics; and secondly, hand skin care benefits, mainly skin softness/smoothness and improved skin appearance, through mild skin exfoliation.

The abrasive particle size may be important to achieve efficient cleaning performance whereas excessively abrasive population with small particle sizes e.g.: typically below 10 micrometers feature polishing action vs. cleaning despite featuring a high number of particles per particle weight load in cleaner inherent to the small particle size. On the other hand, abrasive population with excessively high particle size, e.g.: above 1000 micrometers, do not deliver optimal cleaning efficiency, because the number of particles per particle weight load in cleaner, decreases significantly inherently to the large particle size. Additionally, excessively small particle size are not desirable in cleaner/for cleaning task since in practice, small and numerous particles are often hard to remove from the various surface topologies which requires excessive effort by the user to remove, otherwise leaving the surface with visible particles residue. In addition, very small particles do not deliver the desired mild skin exfoliation experience as they are often not tactile detectable to the user and might increase the risk of over-exfoliating the skin as the user does not feel their action. However, excessively large particle are too easily detected visually or provide bad tactile experience while handling or using the cleaner. Therefore, the applicants define herein an optimal particle size range that delivers both optimal cleaning and exfoliating performance, and usage experience.

The abrasive particles have size defined by their area-equivalent diameter (ISO 9276-6:2008(E) section 7) also called Equivalent Circle Diameter ECD (ASTM F1877-05 Section 11.3.2). Mean ECD of particle population is calculated as the average of respective ECD of each particles of a particle population of at least 10 000 particles, preferably above 50 000 particles, more preferably above 100 000 particles after excluding from the measurement and calculation the data of particles having area-equivalent diameter (ECD) of below 10 micrometers. Mean data are extracted from volume-based vs. number-based measurements.

In a preferred embodiment, the abrasive particles have a mean ECD from 10 μm to 1000 μm, preferably from 50 μm to 500 μm, more preferably from 100 μm to 400 μm and most preferably from 150 to 355 μm.

### Natural Abrasive Particles

The natural abrasive particles described herein may comprise pistachio nut shell particles. Such natural abrasive particles may also comprise particles selected from the group consisting of other nut shell particles; particles derived from other plant sources, such as but not limited to stems, roots, leaves, seeds, fruits, and/or wood; and mixtures thereof.

In a preferred embodiment, such natural abrasive particles are comprised at a level of greater than 0.5%, preferably greater or equal to 1%, more preferably greater or equal to 2%, even more preferably greater or equal to 2.5%, still more preferably from 2.5% to 10%, most preferably from 3% to 6%, by weight of the total composition.

In an embodiment, the natural abrasive particles are derived by shearing, graining, milling and/or grinding pistachio and/or other nut shells, preferably pistachio nut shells. Other suitable means include the use of eroding tools such as a high speed eroding wheel with dust collector wherein the surface of the wheel is engraved with a pattern or is coated with abrasive sandpaper or the like to form the abrasive cleaning particles herein.

Preferably, other nut shells are selected from the group consisting of walnut shell, almond shell, hazelnut shell, macadamia nut shell, pine nut shell and mixtures thereof. Most preferred other nut shell is walnut shell.

When other plant sources are comprised in the natural abrasive particles used in the compositions herein, they are preferably derived from rice, corn cob, palm biomass, bamboo, kenaf, loofa, apple seeds, apricot stone, olive stone, cherry stone, peach stone, Tagua palm (Phyleteas genus) seed, Doum palm (Hyphaene genus) seed, Sago palm (Metroxylon genus) seed, wood and mixtures thereof. Preferred are particles derived from wood, olive stone, cherry stone, tagua palm seed endosperm (known as vegetable ivory), and mixtures thereof.

In a most preferred embodiment, the natural abrasive particles consist of pistachio nut shell particles. Without wishing to be bound by theory it is believed that the pistachio nut shell attains the required cleaning, surface safety, and mild skin exfoliation requirements but also improves product aesthetics due to the whiteness of its shell. Thanks to such whiteness of the shell, coating and/or bleaching is no longer necessary in order to attain the desired product aesthetics, thus permitting savings in terms of both cost and manufacturing complexity.

As source for pistachio shell feedstock from which the natural abrasive particle are produced, a number of pistachio species have been found suitable for compositions herein, such as Pistachia L. vera, Pistachia terebinthus, Pistachia altantica, Pistachia chinensis, Pistachia integerrima, Pistachia khinjuk, Pistachia mutica, Pistachia lentiscus, Pistachia acurainata, etc. However, the more preferred species are Pistachia L. vera, Pistachia terebinthus, Pistachia altantica and the most preferred species is Pistachia L. vera due to its ability to produce higher yield of light or white colored shell in addition to higher yield of dehiscent shell e.g.: shell-opening during the nut maturation which helps the separation process of the fruit from the shell. More especially, among the pistachio varieties, preferred cultivars are selected from the group consisting of Kerman, Muntaz, Pontikis, Sirora, Joley, Cerasola, Aegina, Bronte, Trabonella, Red Aleppo, Damghan, and Lassen. The most preferred cultivar is Kerman due to its ability to produce higher yield of whiteness of the shell.

### Combination of Natural Abrasive Particles and Other Abrasive Particles

The compositions herein may comprise a combination of abrasive particles such as polymeric abrasive particles in combination with natural abrasive particles. Preferably, all abrasive particles will have a Shore D hardness of below 90 according to a procedure described in ASTM D2240.

Without wishing to be bound by theory, it is believed that, overall, the combination of both natural and polymeric abrasive particles allows to formulate an effective hand dishwashing formulation with lower total load of abrasives in the formulation which is desirable in order to reduce cost as well as to increase the rheology and aesthetic profiles of the final composition.

In a preferred embodiment, when the composition comprises both natural abrasive particles and polymeric abrasive particles, the ratio of natural abrasive particles to polymeric abrasive particles is from 50 to 1, preferably from 20 to 1, more preferably from 10 to 1, even more preferably from 5 to 1.

In an embodiment the level of natural abrasive particles is from 2% to 6%, preferably from 2.5% to 5%, more preferably from 2.5% to 4%, most preferably from 2.5% to 3%, by weight of the composition, and the level of polymeric abrasive particles is from 0.1% to 2.5%, preferably from 0.1% to 1%, more preferably from 0.1% to 0.5%, even more preferably from 0.1% to 0.25%, by weight of the composition.

In one embodiment the polymeric abrasive particles herein may be produced by shearing, graining, milling and/or grinding a polymeric material foam, preferably rigid in form. Without wishing to be bound by theory is believed that effective cleaning synergy is achieved when mixing polymeric and natural abrasives both featuring effective shape for cleaning. The applicant has found that grinding polymeric material foam is a particularly preferred process to produce polymeric abrasives with effective shape, although other less preferred processes are also possible such as printing, extruding, molding, etc.

The polymeric material may be selected from the group consisting of polyurethane; polyhydroxy alkanoate derivatives (PHA) such as but not limited to polyhydroxy butyrate, polyhydroxy hexanoate, polyhydroxy valerate, polyhydroxy butyrate-valerate, polyhydroxy butyrate-hexanoate and mixtures thereof; aliphatic polyesters such as polybutylene succinate (PBS), polybutylene adipate (PBA), polybutylene succinate-co-adipate (PBSA) and mixtures thereof; polylactic acid derivatives (PLA); polystyrene; melamine-formaldehyde; polyacrylate; polyolefins such as polyethylene, polypropylene; polyvinyl chloride; and/or polyvinyl acetate. Most preferred is polyurethane.

Most preferably the polymeric abrasive particles are made from a rigid polyurethane foam formed in the reaction between diisocyanate monomers and polyols.

### Hardness of the Particles

Preferred abrasive particles suitable for use herein are hard enough to provide good cleaning/cleansing performance, whilst providing a good surface safety profile, and highly desirable mild skin exfoliation.

Preferred are abrasive particles having a Shore D hardness of from 40 to 90, preferably from 50 to 90, more preferably from 60 to 85, even more preferably from 70 to 80, according to ASTM D2240-05 (2010).

### Surfactants

The present invention comprises at least one surfactant. Suitable surfactants are selected from the group consisting of nonionic, anionic, cationic surfactants, amphoteric, zwitterionic, semi-polar nonionic surfactants, and mixtures thereof. Surfactants may be comprised at a level of from about 1.0% to about 50% by weight, preferably from about 5% to about 40% by weight, more preferably about 10% to about 30% by weight and even more preferably from about 5% to about 20% by weight of the liquid detergent composition. Non-limiting examples of suitable surfactants are discussed below.

In a preferred embodiment, an efficient but mild to hands surfactant system will typically comprise about 4% to about 40%, preferably about 6% to about 32%, more preferably about 11% to about 25%, and most preferably about 11% to about 18% by weight of the total composition of an anionic surfactant and so preferably with no more than about 15%, preferably no more than about 10%, more preferably no more than about 5% by weight of the total composition, of a sulfonate surfactant.

Suitable anionic surfactants to be used in the compositions and methods of the present invention are sulfate, sulfosuccinates, sulfonate, and/or sulfoacetate; preferably alkyl sulfate and/or alkyl ethoxy sulfates; more preferably a combination of alkyl sulfates and/or alkyl ethoxy sulfates with a combined ethoxylation degree less than about 5, preferably less than about 3, more preferably less than about 2.

In an alternative embodiment, the surfactant system could be based on high levels of nonionic surfactant (Such as about 10% to about 45%, preferably about 15 to about 40%, more preferably about 20 to about 35% by weight of the total composition), preferably combined with an amphoteric surfactant, and more preferably with a low level of anionic surfactant (such as less than 20%, preferably less than 10%, more preferably less than about 5% by weight of the total composition).

### Sulfate Surfactants

Suitable surfactants for use in the compositions herein include water-soluble salts or acids of C₁₀-C₁₄ alkyl or hydroxyalkyl, sulfate and/or ether sulfate. Suitable counterions include hydrogen, alkali metal cation or ammonium or substituted ammonium, but preferably sodium.

Where the hydrocarbyl chain is branched, it preferably comprises C₁₋₄ alkyl branching units. The average percentage branching of the sulfate surfactant is preferably greater than 30%, more preferably from 35% to 80% and most preferably from 40% to 60% of the total hydrocarbyl chains.

The sulfate surfactants may be selected from C₈-C₂₀ primary, branched-chain and random alkyl sulfates (AS); C₁₀-C₁₈ secondary (2,3) alkyl sulfates; C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303.

### Alkyl Sulfosuccinates—Sulfoacetate

Other suitable anionic surfactants are alkyl, preferably dialkyl, sulfosuccinates and/or sulfoacetate. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moiety.es). Preferably, the alkyl moiety is symmetrical.

### Sulfonate Surfactants

The compositions of the present invention will preferably comprise no more than 10% by weight, preferably no more than 8%, even more preferably no more than 5% by weight of the total composition, of a sulfonate surfactant. These include water-soluble salts or acids of C₁₀-C₁₄ alkyl or hydroxyalkyl, sulfonates; C₁₁-C₁₈ alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). These also include the paraffin sulfonates may be monosulfonates and/or disulfonates, obtained by sulfonating paraffins of 10 to 20 carbon atoms. The sulfonate surfactants also include the alkyl glyceryl sulfonate surfactants.

### Amphoteric and Zwitterionic Surfactants

The amphoteric and zwitterionic surfactant may be comprised at a level of from 0.01% to 20%, preferably from 0.2% to 15%, more preferably 0.5% to 12% by weight of the liquid detergent composition. Suitable amphoteric and zwitterionic surfactants are amine oxides and betaines.

Most preferred are amine oxides, especially coco dimethyl amine oxide or coco amido propyl dimethyl amine oxide. Amine oxide may have a linear or mid-branched alkyl moiety. Typical linear amine oxides include water-soluble amine oxides of formula R¹—N(R²)(R³)→(O) wherein R¹ is a C₈₋₁₈ alkyl moiety; R² and R³ are independently selected from the group consisting of C₁₋₃ alkyl groups and C₁₋₃ hydroxyalkyl groups and preferably include methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

Other suitable surfactants include betaines such alkyl betaines, alkylamidobetaine, imidazoliniumbetaine, sulfobetaine (INCI Sultaines), and phosphobetaine.

A preferred surfactant system is a mixture of anionic surfactant and amphoteric or zwiterionic surfactants in a ratio within the range of 1:1 to 5:1, preferably from 1:1 to 3.5:1.

It has been found that such surfactant system will provide the excellent cleaning and suds profile required from a hand dishwashing liquid composition while being mild to the hands.

### Nonionic Surfactants

Nonionic surfactant, when present as co-surfactant, is comprised in a typical amount of from 0.1% to 20%, preferably 0.5% to 15%, more preferably from 0.5% to 10% by weight of the liquid detergent composition. When present as main surfactant, it is comprised in a typical amount of from 0.1 to 45%, preferably 15 to 40%, more preferably 20 to 35% by weight of the total composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 moles of ethylene oxide per mole of alcohol.

Also suitable are alkylpolyglycosides having the formula R²O(CₙH₂ₙO)_{T}(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. Also suitable are alkylglycerol ethers and sorbitan esters.

Also suitable are fatty acid amide surfactants having an alkyl group containing from 7 to 21, preferably from 9 to 17, carbon atoms and an amide group selected from C₈-C₂₀ ammonia amides, monoethanolamides, diethanolamides, and isopropanolamides.

### Cationic Surfactants

Cationic surfactants, when present in the composition, are present in an effective amount, more preferably from 0.1% to 20%, by weight of the liquid detergent composition. Suitable cationic surfactants are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyehthyl or hydroxypropyl groups. Another preferred cationic surfactant is an C₆-C₁₈ alkyl or alkenyl ester of a quaternary ammonium alcohol, such as quaternary chlorine esters.

### Other Optional Components

The liquid detergent compositions herein can further comprise a number of other optional ingredients suitable for use in liquid detergent compositions such as Magnesium ions, solvents, hydrotropes, polymeric suds stabilizers, thickeners and rheology modifiers, internal and/or external suspending aids, alkoxylated polyethyleneimine polymers, cationic polymers, polymeric rheology modifiers, linear or cyclic carboxylic acids, pearlescent agents and opacifiers, diamines, humectants, hydrophobic emollients, enzymes such as protease, perfume, dyes, chelants, skin rejuvenating agents, pH buffering means. A further discussion of acceptable optional ingredients suitable for use in light-duty liquid detergent composition may be found in U.S. Pat. No. 5,798,505.

### Cleaning Performance Test Method

First time “neat” product cleaning performance may be evaluated by the following test method: Tiles, typically glossy, white, enamel 24 cm×4 cm, are prepared by applying to them either 0.6 g pure vegetable oil mix (peanut, sunflower and corn oil at equal proportions) or 0.5 g Knorr white sauce mix (prepared according to the manufacturer instructions). Soils are spread using a paint roller to obtain a uniform layer on top of the tile. Tiles are baked in an oven at 145° C. for 2 hours and 10 minutes (vegetable oil mix) or at 180° C. for 45 minutes (white sauce) and kept in a constant temperature and humidity cabinet (25° C., 70% relative humidity) until used. To test cleaning performance, tiles are placed on a Wet Abrasion Scrub Tester with four cleaning tracks equipped with four sponge holders (such as made by Sheen Instruments Ltd. Kingston, England). Four new cellulose kitchen sponges (such as Spontex®) of dimensions 4 cm×8.5 cm (and 4.5 cm thick) are wetted with 25 g of water at 15 gpg water hardness and placed in the sponge holders.

Four g of either test or reference compositions are applied to the sponges. Sponge holders are turned down so that the sponges are placed directly on top of the soiled tile. The abrasion tester can be configured to supply pressure (e.g. 200 g, 400 g, 600 g or 700 g), and move the sponge over the test surface with a set stroke length (e.g.: 30 cm), at set speed (e.g.: 37 strokes per minute). The ability of the composition to remove soil is measured through the number of strokes needed to perfectly clean the surface, as determined by visual assessment. In this context, one stroke means a single movement of the carriage equipped with the four sponges comprising the cleaning product over the tile to be cleaned. The lower the number of strokes, the higher the cleaning ability of the composition.

The soil is regarded as having been removed fully when the operator can no longer see the soil with the naked eye. Eight soiled tiles are used per test and the product position is randomized so that each product is tested in the four different cleaning tracks of the wet Abrasion Scrub Tester at least once. Results are shown in Example 1.

### Peak-to-Peak, Protrusion Height and Protrusion Length Method

Topography measurements of the protrusions on texture-delivering packaging are measured via computer-controlled fringe-projection optical profilometry. Optical profilometer systems measure the physical dimensions of the test surface, resulting in a map of surface height (z), versus lateral displacement in the x-y plane. A suitable optical profilometer instrument will have a field of view and x-y resolution such that the acquired images possess at least 10 pixels linearly across the narrowest feature being measured. A suitable instrument is a GFM Mikrocad system running ODSCAD software version 4 or 6, or equivalent, available from GFMessthechnik GmbH, Teltow, Germany.

To make transparent or translucent samples suitably opaque for accurate measurement of the surface features, the surface to be measured is lightly sprayed with a very fine white powder spray. Preferably this spray is NORD-TEST Developer U 89, available from Helling GmbH, Heidgraben, Germay, which is sold for the detection of cracks in metal objects and welds. Care is taken to deposit only the minimum amount of white spray needed to create a reflective white coating.

Samples should be equilibrated at 23° C.±2 C.° and 50%±2% relative humidity for at least 2 hours immediately before acquiring measurements.

The area to be measured is restricted solely to the area having protrusions, and excluding other areas or zones that might be present on the packaging. The area of the packaging that is measured may be curved or flat due to the overall shape of the packaging and the specific location of the protrusions on that packaging. The area of protrusions to be measured is selected from a flat or the least-curved area of the packaging shape that possesses the protrusions of interest. The sample is placed with the surface area to be measured facing upward, underneath and normal to, the profilometer's projection head. The instrument manufacturer's instructions are followed, and optimized illumination and reflection requirements are achieved as outlined by the manufacturer. Images are then captured and stored as 8-bit grayscale.

Any portion of the image that is not a part of the area being measured should be cropped out of the captured image. Such cropping must occur prior to any further image processing, filtering or measurement analysis. The size of the resultant cropped image may vary between samples and images, depending upon the dimensions of the area containing protrusions.

Prior to making measurements, the images are processed in the instrument software, in order to lightly smooth noise in the images, and to reduce irregularity or curvature due to the sample's overall shape. This noise filtering processing includes the removal of invalid pixel values (those black pixels having a grey value at the far limit of the grayscale range), and the removal of spike values or outlier peaks (those very bright pixels identified by the software as statistical outliers). A polynomial high-pass filter is then utilized with settings of: n=8, difference.

Measurements are then made from the images to yield the spatial parameters: protrusion height (H), peak-to-peak distance (P), and protrusion length (L). These measurements are achieved by defining straight line regions of interest within the image and generating height profiles along these straight lines.

The height (H) is measured in the z-axis, as the vertical straight-line distance from the height of the lowest point of the adjacent recess 5, to the height of the apex of the protrusion 6 being measured. The peak-to-peak distance (P), is measured in the x-y plane, as the horizontal straight line distance from the apex of the protrusion 6 being measured, to the apex of its nearest neighbor protrusion 6. The length (L) of a protrusion 6, is measured in the x-y plane, as the straight line distance along the protrusion's longest axis, from the junction of recess 5 and protrusion 6 at one end of the axis, to the similar junction on the other end of the axis.

Where a sample has protrusions that appear to fall into two or more distinct classes, as determined by visually observing their overall shape and size, then separate values of H and L are to be determined for each protrusion class. Values for P may include protrusions from different classes.

If the packaging visibly appears to have more than one pattern of protrusions in different locations on the packaging, then each pattern is to have its values determined separately from the other pattern(s).

For each pattern to be tested, five replicate packaging samples are imaged, and from each replicate sample measurements are made of at least: 20 protrusion heights (H) for each protrusion class, 20 protrusion lengths (L) for each protrusion class, and 20 peak-to-peak distances (P). All adjacent protrusions within an imaged area are measured, until the total number of protrusions required has been measured. For each parameter calculated for a specific pattern and protrusion class, the values from each of the five replicate packaging samples are averaged together to give the final value for each parameter.

### Surface Damage Method

To measure the surface damage produced by the test particles, 4 g of aqueous solutions comprising the particles of the present invention (3%-5% wt particle in deionized water) are applied to new cellulose kitchen sponges (such as Spontex®) of dimensions 4 cm×8.5 cm (and 4.5 cm thick) wetted with 25 g of deionized water mounted on a Wet Abrasion Scrub Tester Instrument as described in the cleaning performance test method with the particle coated side facing the test surface. Two references are used: Reference 1 is the same cellulose kitchen sponge wetted with 25 g deionized water and loaded with 4 g water no particles, Reference 2 is a medium duty scrubbing sponge such as the ones sold by 3M under the trade mark of Scotch-Brite, placed in the Wet Abrasion Scrub tester sponge holder with the green scrubby side facing the test surface, wetted and loaded as Reference 1 sponge. The test surface to be used should be a new sheet of uncolored, transparent, virgin Poly(methyl methacrylate) (also known as PMMA, Plexiglass, Perspex, Lucite), having a Vickers HV Hardness Value of 25 kg/square mm (+/−2) (as measured using standard test method ISO 14577). The abrasion tester should be configured to supply 600 g of pressure and move the sponge over the test surface with a stroke length of 30 cm, at a speed of 37 strokes per minute. The wet abrasion scrub tester should be allowed to execute 200 strokes (i.e., 200 single-direction displacements), then the sponge is re-loaded with an additional 4 g of abrasive particles in water. The sponge is to be reloaded in this manner every 200 strokes, for five consecutive loadings (i.e., 1000 strokes in total per test surface). Assessment of damage to the test surface is conducted after 1000 strokes have been completed.

To assess surface damage on the Poly(methyl methacrylate) test surface, visual grading is conducted according to the following 5-level surface damage grading scale: 0=I see no scratches; 1=I think I see scratches; 2=I definitely see small scratches; 3=I see lots of scratches; 4=I see a lot of damage. The Visual Damage Grade is the average of the grades given by 2 independent graders. Results are shown in Example 2.

### Exfoliation Method

“In vivo” exfoliation method is based on removal of dihydroxyacetone-induced skin artificial coloration. Dihydroxyacetone has the ability to stain only fully keratinized cells of the epidermis. Removal of the dihydroxyacetone-induced stain is linked to the removal of fully keratinized cells and therefore can provide an estimate of mild skin exfoliation.

The volar forearm area of both left and right arms of two volunteers is artificially tanned using a commercially available sunless tanner comprising dihydroxyacetone. The sunless tanner is applied once a day during a week according to the manufacturer instructions until a homogeneous artificial tan is obtained.

Three treatment sites per arm are marked off using a water proof marker. The three treatments sites of each arm should be centered on the volar forearem between the wrist and inner elbow. Care should be taken not to use the area closest to inner elbow and wrist. One of the 3 treatment sites in each forearm is a non-particle control which is included to demonstrate the mild skin exfoliation benefits provided by the particles. The location of both the non-particle control site and the two particle treatment sites are randomized for each arm and each subject to minimize position effects.

Product treatments: 0.5 ml of each prototype is applied twice a day with at least four hours between product applications for a total of 4 times in their designated treatment site of each forearm. Product is dispensed on the skin using a 2 ml syringe and rubbed with a gloved finger for 10 secondss with circular motions, after all products have been applied in one forearm, skin is rinsed with warm tap water and patted dry with a soft paper tissue taking care not to rub the treatment sites. Skin color measurements are taken as L*,a*,b* values according to the CIELab color scale using a BYK spectro-guide gloss 6801 before each product application, and one hour after the last (4^{th}) product application, according to the equipment instructions. The CIELab color scale is based on the Opponent-Colors Theory which assumes that the human eye perceives color as the following pairs of opposites: Light-Dark, Red-Green, Yellow-Blue. The L* value for each scale indicates the level of light or dark, the a* value the redness or greenness, and the b* value the yellowness or blueness.

Exfoliation benefits provided by the exemplified hand dish products comprising abrasive particles are shown in TABLE 4, in Example 3, by a decrease in the b* value (color removal) after each treatment (T1 to T4) with particle-containing product, and by the difference in b* value (Δb*) between the color of artificially tanned skin before initiating the product treatment (b*BT) and after the last (4^{th}) treatment (b*T4), so that Δb*=b*BT−b*T4. Larger Δb* indicate more color removal and more mild skin exfoliation. The impact of the particles can be seen by the increase in the Δb* after treatment with the particle-containing prototypes. Similarly, skin treated with the particle prototypes shows a b* value closer to that of not tanned (untreated) skin measured in the inner part of the upper arm and that has an average b* of 15.77, demonstrating that the prototypes with particles are more efficient in removing the layer of dead cells stained with the sunless tanner, and in returning the skin to its original color.

### Example 1

TABLE 1
Cleaning performance of exemplified hand dishwashing
detergent compositions comprising natural abrasive particles.

| Composition | Comparative | A | B |
|---|---|---|---|
| Alkyl Ethoxy | 24 | 24 | 24 |
| Sulfate AExS | | | |
| Dimehtyl coco alkyl | 5.3 | 5.3 | 5.3 |
| Amine Oxide | | | |
| Ethanol | 3.25 | 3.25 | 3.25 |
| Polypropyleneglycol | 0.7 | 0.7 | 0.7 |
| NaCl | 1.25 | 1.25 | 1.25 |
| Hydrogenated | 0.24 | 0.24 | 0.24 |
| Castor Oil | | | |
| Particles | — | 3% wt Pistachio | 5% wt |
| | | shell particles | walnut shell |
| | | (250-375 microns) (1) | particles (2) |
| Minors* | Balance to 100% with water | | |
| pH | 9 | 9 | 9 |
| Number of strokes | 28.8 ± 1.49 | 7.4 ± 0.74 | 10.5 ± 1.77 |
| (vegetable grease) | | | |

(1) EcoShell 80 shore D hardness
(2) Bleached walnut shell particles of 200 microns. Evonic Industries 75 shore D hardness.

### Example 2

TABLE 2
Visual surface damage grade of exemplified cleaning and abrasive
particles dispersed in deionized water at the indicated levels.

| Sample | Visual Surface damage Grading |
|---|---|
| 3% Polyurethane foam particles (1) | 0 |
| 5% Pistachio shell particles (2) | 0 |
| 5% Walnut shell particles (3) | 0 |
| Reference 1 - Soft sponge + water | 0 |
| Reference 2 - Scrubby sponge + water | 3 |

(1) From foam having foam density 33 kg/m³/60-90 shore D hardness/Blade mill grinded and sieved fraction 50-355 microns
(2) Particle size ~200 microns. EcoShell, 80 shore D hardness
(3) Particle size of 200 microns. Evonik Industries, 75 shore D hardness

### Example 3

TABLE 3
Exemplified hand dishwashing detergent compositions
comprising abrasive particles.

| Composition | Comparative | C |
|---|---|---|
| Alkyl Ethoxy | 18 | 18 |
| Sulfate AExS | | |
| Dimehtyl coco alkyl | 6 | 6 |
| Amine Oxide | | |
| Citrate | 2.55 | 2.55 |
| Polypropyleneglycol | 0.8 | 0.8 |
| NaCl | 0.5 | 0.5 |
| Particles | — | 5% pistachio shell |
| | | particles 250-375 |
| | | microns (1) |
| Hydrogenated | 0.24 | 0.24 |
| Castor Oil | | |

| | |
|---|---|
| Minors* | Balance to 100% |

| | | |
|---|---|---|
| pH | 9 | 9 |

(1) Ecoshell/80 shore D hardness

TABLE 4
Average b* value before treatment and after treatment with
each product four times

| | Dyed skin before | |
|---|---|---|
| | treatment with hand dish | |
| Product | prototypes (BT) | Δb* BT-T4 |
| Comparative 3 | 22.71 | 1.02 |
| B | 23.51 | 3.85 |

### Example 4

### Liquid Dishwashing Detergent Compositions

| % Weight | D | E | F | G | H | I | J | K | L | M | N |
|---|---|---|---|---|---|---|---|---|---|---|---|
| Alkyl Ethoxy | 18 | 24 | 14 | 14 | 9 | — | 5 | 9 | 18 | 24 | 15.2 |
| Sulfate | | | | | | | | | | | |
| Linear Alkylbenzene | — | — | — | — | 11 | — | 15 | 4 | — | — | — |
| Sulfonate | | | | | | | | | | | |
| Paraffin Sulfonate | — | — | — | 8 | — | — | — | — | — | — | — |
| Coco amido propyl | — | — | — | — | 6 | — | — | 4 | — | — | — |
| Betaine | | | | | | | | | | | |
| Ethoxylated alkyl | — | — | — | 3 | 2 | 33 | 1 | — | — | — | 4.7 |
| alcohol | | | | | | | | | | | |
| Dimehtyl coco alkyl | 6 | 5.3 | 4 | — | 2 | 2 | — | — | 6 | 5.3 | 5.1 |
| Amine Oxide | | | | | | | | | | | |
| Alkylpolyglucoside | — | — | — | 6 | — | — | 6 | — | — | — | — |
| Ethanol | — | 1.5 | 3 | 3 | 1 | 9 | 2 | 3 | — | 1.5 | 0.7 |
| Polypropyleneglycol | 0.8 | 0.7 | 0.2 | — | 0.5 | 0.3 | 0.2 | — | 0.8 | 0.7 | 0.25 |
| Citrate | 2.5 | — | | 0.3 | — | — | — | — | 2.5 | — | — |
| NaCl | 0.5 | 1.25 | — | — | 0.25 | — | — | 0.5 | 0.5 | 1.25 | 0.5 |
| Sodium cumene | — | — | — | 0.6 | — | 3 | 2 | 2 | — | — | — |
| sulfonate | | | | | | | | | | | |
| Glutamic acid-N,N- | — | — | — | 0.3 | 0.6 | — | — | 0.5 | — | — | 0.7 |
| diacetic acid | | | | | | | | | | | |
| (GLDA) | | | | | | | | | | | |
| Polyurethane foam | — | — | — | — | — | 1 | 0.5 | 0.25 | — | — | — |
| particles (1) | | | | | | | | | | | |
| Polyhydroxybutyrate | — | — | — | — | — | — | — | — | 2 | — | — |
| valerate foam | | | | | | | | | | | |
| particles (2) | | | | | | | | | | | |
| Polylactic acid foam | — | — | — | — | — | — | — | — | — | 1.5 | — |
| particles (3) | | | | | | | | | | | |
| Bleached Walnut | 5 | — | — | 3 | — | — | 2.5 | — | — | — | — |
| shell particles ~200 | | | | | | | | | | | |
| microns (4) | | | | | | | | | | | |
| Olive stone particles | — | — | 3 | — | 5.5 | — | — | — | — | 2.5 | — |
| 150-250 microns (5) | | | | | | | | | | | |
| Pistachio shell | 1 | 4 | 1.5 | — | — | 2 | 0.5 | 2.5 | 0.25 | — | 3 |
| particles 250-375 | | | | | | | | | | | |
| microns (6) | | | | | | | | | | | |
| Cationic polymer (7) | 0.1 | — | — | — | — | 0.2 | — | — | — | 0.15 | 0.1 |
| Hydrogenated | — | 0.3 | 0.2 | — | 0.2 | — | — | 0.1 | — | — | — |
| Castor Oil | | | | | | | | | | | |
| MFC CP Kelko | 0.15 | — | 0.02 | 0.05 | — | 0.03 | 0.1 | — | — | — | 0.2 |
| Dibenzylidene | — | — | — | — | — | — | — | — | 0.3 | — | — |
| Sorbitol (8) | | | | | | | | | | | |
| Amido-gellant (9) | — | — | — | 0.2 | — | — | — | — | — | 0.25 | — |
| Ethylene glycol | 0.4 | — | — | — | — | 0.8 | — | 0.4 | — | 0.3 | 0.35 |
| diesterate | | | | | | | | | | | |
| Opacifier (10) | — | — | 0.05 | — | 0.02 | | — | — | 0.03 | — | — |
| Petrolatum | — | — | | — | — | — | 0.5 | — | — | 0.5 | — |
| glycerol | — | — | | 2 | — | — | — | — | — | 1 | — |
| Minors | Balance to 100% with water | | | | | | | | | | |
| pH | 9 | 9 | 8.7 | 7 | 7 | 6.5 | 6 | 7 | 9 | 8.5 | 9.2 |

*Minors: dyes, perfumes, preservatives, hydrotropes, processing aids, stabilizers
(1) From foam having foam density 33 kg/m³/60-90 shore D hardness/Blade mill grinded and sieved fraction 50-355 microns
(2) Blade mill grinded and sieved fraction 250-355 microns60-90 shore D hardness
(3) Blade mill grinded and sieved fraction 150-250 microns60-90 shore D hardness
(4) Evonik Industries/75 shore D hardness
(5) J. Rettenmaier & Söhne Gmbh + Co.KG 81 shore D hardness
(6) Ecoshell/80 shore D hardness
(7) Guar hydroxypropyl trimonium chloride
(8) Millithix 925S Milliken
(9) N,N′-(2S,2′S)-1,1′-(dodecane-1,12-diylbis(azanediyl))bis(3-methyl-1-oxobutane-2,1-diyl)diisonicotinamide
(10) Acusol ™ OP301 ex. Rohm and Haas

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged product comprising a packaging in combination with a composition, said composition comprising at least one surfactant and abrasive particles to provide both cleaning of a surface and mild skin exfoliation benefits, wherein said composition consists of a liquid composition and characterized in that said packaging comprises a textured surface to provide tactile cues to the delivery of the cleaning and exfoliating benefits of said composition.

2. A packaged product according to claim 1 wherein said composition consists of a hand dishwashing composition.

3. A packaged product according to claim 1 wherein said textured surface consists of a plurality of recesses and protrusions on at least a portion of said packaging.

4. A packaged product according to claim 1 wherein said packaging comprises a closure and a body, and wherein said textured surface is on at least a portion of said body.

5. A packaged product according to claim 1 wherein said packaging further comprises an overlaying material selected from the group consisting of adhesive labels, sleeves, and combinations thereof, wherein said overlaying material comprises the textured surface.

6. A packaged product according to claim 1 comprising recesses and protrusions which are substantially blunt.

7. A packaged product according to claim 3 wherein said protrusions have an aspect ratio (H:L) between 1.5 and 5.

8. A packaged product according to claims 3 wherein each said recess is delimited by at least one protrusion.

9. A packaged product according to claim 3 wherein each said protrusion is delimited by at least one recess.

10. A packaged product according to claim 3 wherein the peak-to-peak distance “P” between two consecutive protrusions is greater than at least 1.5 times the length “L” of one said protrusion.

11. A packaged product according to claim 3 wherein the peak-to-peak distance “P” between two consecutive protrusions is greater than from 2 to 5 times the length “L” of one said protrusion.

12. A packaged product according to claim 1 comprising recesses and protrusions which generate a substantially random pattern and/or the height “H” of the protrusions is substantially random.

13. A packaged product according to claim 1 wherein said textured surface is provided with means to attract the user to touch said textured surface.

14. A packaged product according to claim 3 wherein said protrusions are elevated from the outer packaging surface, said outer packaging surface being the surface opposite the surface of the packaging that is in contact with said composition.

15. A packaged product according to claim 1 wherein said abrasive particles are selected from the group consisting of natural abrasive particles, particles derived from polymeric material foam, and mixtures thereof.
